(19) United States
(12) Patent Application Publication
(10) Pub. No.: US 2007/0181442 A1
(43) Pub. Date: Aug. 9, 2007

(54) Method and apparatus for foam removal in an electrochemical mechanical substrate polishing process

(75) Inventors: Renhe Jia, Berkeley, CA (US); Jie Diao, San Jose, CA (US); You Wang, Cupertino, CA (US); Stan D. Tsai, Fremont, CA (US); Lakshmanan Karuppiah, San Jose, CA (US)

Correspondence Address: PATTERSON & SHERIDAN, LLP, 3040 POST OAK BOULEVARD, SUITE 1500, HOUSTON, TX, 77056, US

(73) Assignee: Applied Materials, Inc.

(21) Appl. No.: 11/346,891

(22) Filed: Feb. 3, 2006

(51) Int. Cl. B23H 7/00

(52) U.S. Cl. 205/650

(57) ABSTRACT

The embodiments of the invention generally relate to a method and apparatus for processing a substrate where reduced defect formation is desired. Embodiments of the invention may be beneficially practiced in chemical mechanical polishing and electrochemical mechanical polishing processes, among other processes where reduction in defect formation due to foam formation is desired. In one embodiment, a processing system for planarizing a substrate is provided that includes a platen, a pad disposed on the platen, a carrier head configured to retain the substrate against the pad while contacting an electronically conductive processing solution; and a foam removal assembly. The foam removal assembly is configured to remove foam from the electrically conductive processing solution, wherein a gap exists between a surface of the electrically conductive processing solution and a bottom edge of the foam removal assembly.

### BACKGROUND OF THE INVENTION

1. Field of the Invention

Embodiments of the present invention generally relate to methods and apparatus for polishing a substrate in an electrochemical mechanical polishing system.

2. Description of the Related Art

Electrochemical Mechanical Processing (ECMP) is a technique used to remove conductive materials from a substrate surface by electrochemical dissolution while concurrently polishing the substrate with reduced mechanical abrasion as compared to conventional Chemical Mechanical Polishing (CMP) processes. ECMP systems may generally be adapted for deposition of conductive material on the substrate by reversing the polarity of the bias applied between the substrate and an electrode. Electrochemical dissolution is performed by applying a bias between a cathode and a substrate surface (acting as an anode) to remove conductive materials from the substrate surface into a surrounding electrolyte. The bias may be applied to the substrate surface by a conductive contact disposed on or through a polishing material upon which the substrate is processed. The polishing material may be, for example, a conductive polishing pad disposed on a platen. A mechanical component of the polishing process is performed by providing relative motion between the substrate and the polishing material that enhances the removal of the conductive material from the substrate.

When a bias is applied to the cathode and the substrate surface, the conductive metal layer under anodic polarization is converted into metal ions. These metal ions complex with chelating agents in the surrounding electrolyte. During this process, individual bubbles form at both the anode and the cathode, with oxygen being the main anodic product and hydrogen the main cathodic product. These individual bubbles can adhere to the wafer surface during polishing and block the electrical dissolution path, leading to different polishing rates for the foam covered and the foam free areas. These different polishing rates lead to “bubble defects” on the polished surface. As removal rates increase, foam production also increases thus leading to increased “bubble defects.” These increased “bubble defects” pose technical roadblocks for developing high throughput processes. Further, the foam can be transferred from platen to platen with the wafer, thus causing cross-contamination between platens.

Therefore, there exists a need for a method and apparatus for polishing a substrate while reducing the amount of foam in the electrolyte bath during the polishing process.

### SUMMARY OF THE INVENTION

The embodiments of the invention generally relate to a method and apparatus for processing a substrate with reduced defect formation. Embodiments of the invention may be beneficially practiced in chemical mechanical polishing and electrochemical mechanical polishing processes, among other processes where reduction in defect formation due to foam formation is desired.

In one embodiment, a processing system for planarizing a substrate is provided that includes a platen, a pad disposed on the platen, a carrier head configured to retain the substrate against the pad while contacting an electronically conductive processing solution; and a foam removal assembly. The foam removal assembly is configured to remove the foam from the electrically conductive processing solution. A gap exists between a surface of the electrically conductive solution and a bottom edge of the foam removal assembly. In another embodiment, the processing system further comprises a fluid delivery arm, an electrode disposed between the platen and the pad, and a power source having a pole coupled to the electrode. In another embodiment, the foam removal assembly is positioned at an angle in a plane parallel to the platen between about 200 and about 70° relative to the edge of the platen. In another embodiment, the foam removal assembly is positioned at an angle in a plane parallel to the platen between about 30° to about 45°.

In one embodiment, an apparatus for defoaming an electrochemical mechanical polishing bath is provided. The apparatus comprises a foam removal assembly and a fluid delivery arm attached to the foam removal assembly.

In one embodiment, a method of electrochemically and mechanically planarizing a surface of a substrate is provided. The method comprises providing a basin containing an electrically conductive solution and an electrode disposed therein, disposing a polishing medium in the electrically conductive solution, positioning a substrate against the polishing medium so that a surface of the substrate contacts the electrically conductive solution, providing a relative motion between the substrate and the polishing medium, applying a potential between the polishing medium and the electrode, and skimming a surface of the electrically conductive solution with a foam removal assembly.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 is a partial sectional view of one embodiment of a processing station that includes one embodiment of a foam removal assembly attached to a fluid delivery apparatus.

FIG. 2 is a plan view of the processing station of FIG. 1.

FIG. 3 is a plan view of another embodiment of the processing station of FIG. 1.

FIG. 4 is a partial sectional view of one embodiment of the foam removal assembly.

FIG. 5 is a plan view of an electrochemical mechanical processing system.

To facilitate understanding, identical reference numerals have been used, where possible, to designate identical elements that are common to the figures. It is contemplated that elements and features of one embodiment may be beneficially incorporated in other embodiments without further recitation.

it is to be noted, however, that the appended drawings illustrate only typical embodiments of this invention and are therefore not to be considered limiting of its scope, for the invention may admit to other equally effective embodiments.

### DETAILED DESCRIPTION

A method and apparatus for defect reduction via foam removal in an electrochemical substrate polishing process is provided. The method and apparatus may be utilized in systems where foam removal from a processing solution on a rotating work surface is desired. Although the embodiments below focus on removing foam from an electrochemical mechanical polishing process, it is contemplated that the teachings within may also be used in other polishing processes as well as depositing materials on a substrate by reversing the polarity of an electrical bias applied between a substrate and an electrode of the system.

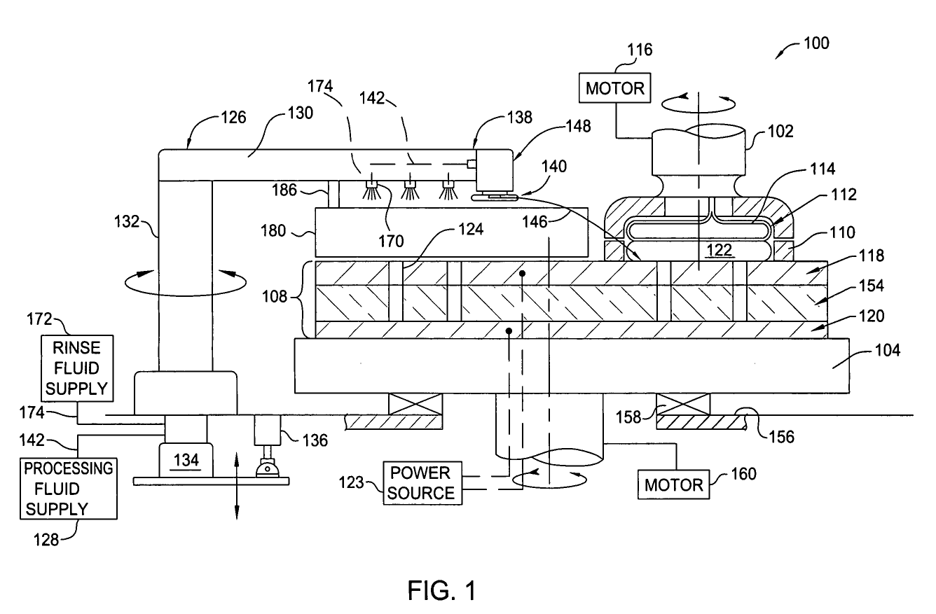

FIG. 1 is a partial sectional view of one embodiment of a processing station 100 that includes one embodiment of the foam removal assembly 180 for removing foam from the electrolyte bath. The foam removal assembly 180 is attached to a fluid delivery arm assembly 126. Although the processing station 100 illustrated in FIG. 1 as an electrochemical mechanical processing station, it is contemplated that the invention may be practiced in other electroprocessing stations and conventional chemical mechanical polishing stations.

Referring to FIG. 1, the processing station 100 includes a carrier head 102 and a platen 104. The carrier head 102 generally retains a substrate 122 against a polishing pad 108 disposed on the platen 104. At least one of the carrier head 102 or platen 104 is rotated or otherwise moved to provide relative motion between the substrate 122 and the polishing pad 108. In the embodiment depicted in FIG. 1, the carrier head 102 is coupled to an actuator or motor 116 that provides at least rotational motion to the substrate 122. The motor 116 may also oscillate the carrier head 102, such that the substrate 122 is moved laterally back and forth across the surface of the polishing pad 108.

In one embodiment, the carrier head 102 includes a retaining ring 110 circumscribing a substrate receiving pocket 112. A bladder 114 is disposed in the substrate receiving pocket 112 and may be evacuated to chuck the wafer to the carrier head 102 and pressurized to control the downward force of the substrate 122 when pressed against the polishing pad 108. One suitable carrier head 102 is a TITAN HEAD™ carrier head available from Applied Materials, Inc., located in Santa Clara, Calif. Another example of a carrier head that may be adapted to benefit from the invention is described in U.S. Pat. No. 6,159,079, issued Dec. 12, 2001, which is hereby incorporated herein by reference in its entirety.

In FIG. 1, the platen 104 is supported on a base 156 by bearings 158 that facilitate rotation of the platen 104. A motor 160 is coupled to the platen 104 and rotates the platen 104 such that the pad 108 is moved relative to the carrier head 102.

In the embodiment depicted in FIG. 1, the polishing pad 108 includes an upper conductive layer 118 and an underlying electrode 120. Optionally, one or more intervening layers 154 may be disposed between the electrode 120 and conductive layer 118. For example, the intervening layers 154 may include at least one of a subpad, an interposed pad and a conductive carrier. In one embodiment, the subpad may be a urethane-based material, such as a foam urethane. In one embodiment, the interposed pad may be a sheet of mylar. In one embodiment, the conductive carrier may be a metallic foil. In one embodiment, the top conductive layer 118 may be comprised of one or more conductive films, such as one or more films comprised of a conductive material suspended in a polymer binder. Optionally, the films may be disposed on a conductive fabric for increased mechanical strength.

The electrode 120 is generally fabricated from a conductive material and may optionally include two or more independently biasable zones. In one embodiment, the electrode 120 is fabricated from stainless steel.

The conductive layer 118 and the electrode 120 are coupled to opposite poles of a power source 123. The power source 123 is generally configured to provide a potential difference between the conductive layer 118 and the electrode 120 of up to about 12 volts DC. The power source 123 may be configured to drive an electrochemical process utilizing constant voltage, constant current or a combination thereof. The power source 123 may also provide power pulses.

A plurality of holes 124 are formed through at least the top conductive layer 118 of the pad 108, such that a processing fluid filling the holes 124 may establish a conductive path between the electrode 120 and the substrate 122 disposed on the top conductive layer 118. The number, size, distribution, open area and pattern density of the holes 124 may be selected to obtain a desired processing result. Some examples of suitable pads which may be adapted to benefit from the invention are described in U.S. patent application Ser. No. 10/455,895 filed Jun. 6, 2003 and U.S. patent application Ser. No. 10/642,128 filed Aug. 15, 2003, which are hereby incorporated by reference in their entireties.

A fluid delivery arm assembly 126 is utilized to deliver a processing fluid from a processing fluid supply 128 to a top or working surface of the conductive layer 118. In the embodiment depicted in FIG. 1, the fluid delivery arm assembly 126 includes an arm 130 extending from a stanchion 132. A motor 134 is provided to control the rotation of the arm 130 about a center line of the stanchion 132. An adjustment mechanism 136 may be provided to control the elevation of a distal end 138 of the arm 130 relative to the working surface of the pad 108. The adjustment mechanism 136 may be an actuator coupled to at least one of the arm 130 or the stanchion 132 for controlling the elevation of the distal end 138 of the arm 130 relative to the platen 104. Some examples of suitable fluid delivery arms which may be adapted to benefit from the current invention are described in co-pending U.S. patent application Ser. No. 11/298,643, filed Dec. 8, 2005, entitled “Method And Apparatus For Planarizing A Substrate With Low Fluid Consumption,” which is hereby incorporated by reference in its entirety to the extent not inconsistent with this application.

The fluid delivery arm assembly 126 may include a plurality of rinse outlet ports 170 arranged to deliver a spray and/or stream of rinsing fluid to the surface of the pad 108. The ports 170 are coupled by a tube 174 routed through the fluid delivery arm assembly 126 to a rinsing fluid supply 172. The rinsing fluid supply 172 provides a rinsing fluid, such as deionized water, to the pad 108 after the substrate 122 is removed to clean the pad 108. The pad 108 may also be cleaned using fluid from the ports 170 after conditioning the pad using a conditioning element, such as a diamond disk or brush (not shown).

The nozzle assembly 148 is disposed at the distal end of the arm 130. The nozzle assembly 148 is coupled to the fluid supply 128 by a tube 142 routed through the fluid delivery arm assembly 126. The nozzle assembly 148 includes a nozzle 140 that may be selectively adjusted relative to the arm, such that the fluid exiting the nozzle 140 may be selectively directed to a specific area of the pad 108.

In one embodiment, the nozzle 140 is configured to generate a spray of processing fluid. In another embodiment, the nozzle 140 is adapted to provide a stream of processing fluid. In another embodiment, the nozzle 140 is configured to provide a stream and/or spray of processing fluid 146 at a rate between about 20 to about 120 cm/second to the polishing surface.

In one embodiment, the foam removal assembly 180 is attached to the fluid delivery arm assembly 126 by a shaft 186. Other common attachment or mounting means known in the art may also be used, for example, the shaft 186 may be attached to the fluid delivery arm assembly 126 by a screw. It is also contemplated that the foam removal assembly 180 be readily detachable from the fluid delivery arm assembly 126. In another embodiment the foam removal assembly 180 is configured for mounting to the base 156. In another embodiment, the foam removal assembly 180 is an integral part of the fluid delivery arm assembly 126.

The foam removal assembly 180 is vertically adjustable along shaft 186. The foam removal assembly 180 should be positioned above the liquid level where it can skim the foam off the surface of the electrolyte bath without creating turbulence in the electrolyte bath. Thus, the elevation of the foam removal assembly 180 relative to the pad 108 is dictated by the height of the electrolyte bath. A gap separates a bottom edge of the foam removal assembly 180 from a top surface of the pad 108. In general, he distance across the gap is greater than the height of the electrolyte bath.

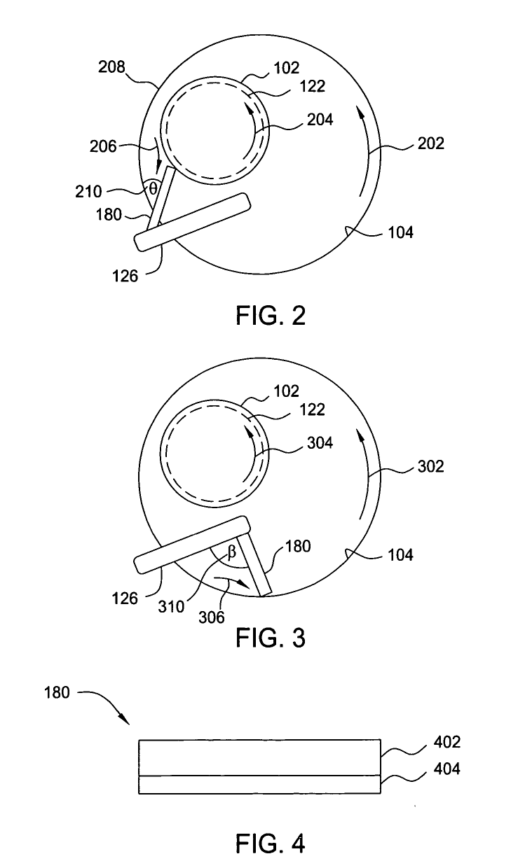

FIG. 2 is a plan view of the processing station of FIG. 1 illustrating the location of the foam removal assembly 180 with respect to the carrier head 102, the substrate 122 and the fluid delivery arm assembly 126 in one embodiment. The foam removal assembly 180 is positioned so it does not interfere with the movement of the carrier head 102. Arrow 202 defines the rotational movement of the platen 104. Arrow 204 defines the rotational movement of the carrier head 102. Arrow 206 defines the movement of foam as it is blocked by the foam removal assembly 180 and swept off the edge 208 of the platen 104 by the rotational movement of the platen 104 represented by arrow 202.

The angle (θ) 210 of the foam removal assembly 180, located in a plane parallel to the platen 104, relative to the edge 208 of the platen 104 should be fixed so that the foam will be pushed out to the edge 208 of and off the platen 104. The angle (θ) 210 of the foam removal assembly 180 relative to the edge 208 of the platen 104 should also be fixed so that the foam removal assembly 180 removes the maximum amount of foam without interfering with the movements of the carrier head 102. In one embodiment, the angle (θ) 210 of the foam removal assembly 180 relative to the edge 208 of the platen 104 is between about 20° to about 70°, and in another embodiment is between about 30° to about 45°.

The foam removal assembly 180 is horizontally adjustable relative to the fluid delivery arm assembly 126. The location and amount of foam formed is dependent upon the speed of the platen 104. As the speed of the platen 104 increases, the electrolyte moves toward the edge of the platen 104 and thus the foam also moves toward the edge of the platen 104. As a result, the angle (θ) 210 of the foam removal assembly 180 can be adjusted as the speed of the platen 104 either increases or decreases for maximum foam removal. Thus the foam removal assembly 180 should be positioned along the angle (θ) 210 so it removes a majority of the foam produced. In one embodiment, a motor (not shown) is provided to control the rotational movement of the foam removal assembly 180.

FIG. 3 is a plan view of another embodiment of the processing station of FIG. 1 illustrating the location of the foam removal assembly 180 with respect to the carrier head 102, the substrate 122 and the fluid delivery arm assembly 126. In this embodiment, the foam removal assembly 180 is attached to the distal end 138 of the fluid delivery arm assembly 126. The foam removal assembly 180 should be positioned so it does not interfere with the movement of the carrier head 102. Arrow 302 defines the rotational movement of the platen 104. Arrow 304 defines the rotational movement of the carrier head 102. Arrow 306 defines the movement of foam as it is blocked by the foam removal assembly 180 and swept off the platen 104 by the rotational movement of the platen 104 represented by arrow 302.

The angle (β) 310 of the foam removal assembly 180, located in a plane parallel to the platen 104, relative to the fluid delivery arm assembly 126 should be fixed so that the foam will be pushed off the platen 104. The angle (β) 310 of the foam removal assembly 180 relative to the fluid delivery arm assembly 126 should also be fixed so that the foam removal assembly 180 does not interfere with the movements of carrier head 102. In one embodiment, the angle (β) 210 of the foam removal assembly 180 relative to the fluid delivery arm assembly 126 is between about 45° to about 120°, and in another embodiment is between about 60° to about 100°, and in a specific embodiment is about 90°. In this embodiment, the foam removal assembly 180 is horizontally adjustable and locks in place for processing.

In another embodiment, the foam removal assembly 180 is positioned at an angle in a plane perpendicular to the polishing medium. In one embodiment, the foam removal assembly 180 is angled downward opposite the rotational movement of the platen defined by arrow 202. In another embodiment, the blade can be curved toward the rotational movement of the platen defined by arrow 202.

The foam removal assembly 180 is fabricated from a material that is compatible with process chemistries. The foam removal assembly 180 can comprise a plastic material such as PPS, PEEK, and the like, or a conductive material selected from the group consisting of stainless steel, copper, gold, silver, tungsten, palladium, bronze, brass, polymers and the like or some combination thereof.

FIG. 4 is a partial sectional view of one embodiment of the foam removal assembly 180. In this embodiment, the foam removal assembly 180 comprises a top portion 402 and a bottom portion 404. The top portion 402 comprises a straight bar having a rectangular cross section. The top portion 402 needs to be sufficiently rigid so it does not bend or flex. The bottom portion 404 is slidably attached to the top portion 402 of the foam removal assembly 180 and can be replaced as needed. The bottom portion 404 may comprise one or more blades extending along the underside of the top portion 402. The blade is formed from a material that does not react with process chemistries. In one embodiment, the bottom portion 404 is thin enough to flex from side to side. In one embodiment, the foam removal assembly 180 comprises more than one material, for example, the top portion 402 of the foam removal assembly 180 comprises a material such as stainless steel and the bottom portion 404 of the foam removal assembly comprises a material such as PPS or PEEK. In another embodiment, the foam removal assembly 180 comprises a unitary piece comprising a single material.

In another embodiment, the foam removal assembly 180 comprises a brush with a plurality of bristles. The bristles are preferably packed together in a high density that projects downward from the fluid delivery arm assembly 126. The foam removal assembly 180 can comprise any shape or material that properly removes foam from the surface of the electrolyte.

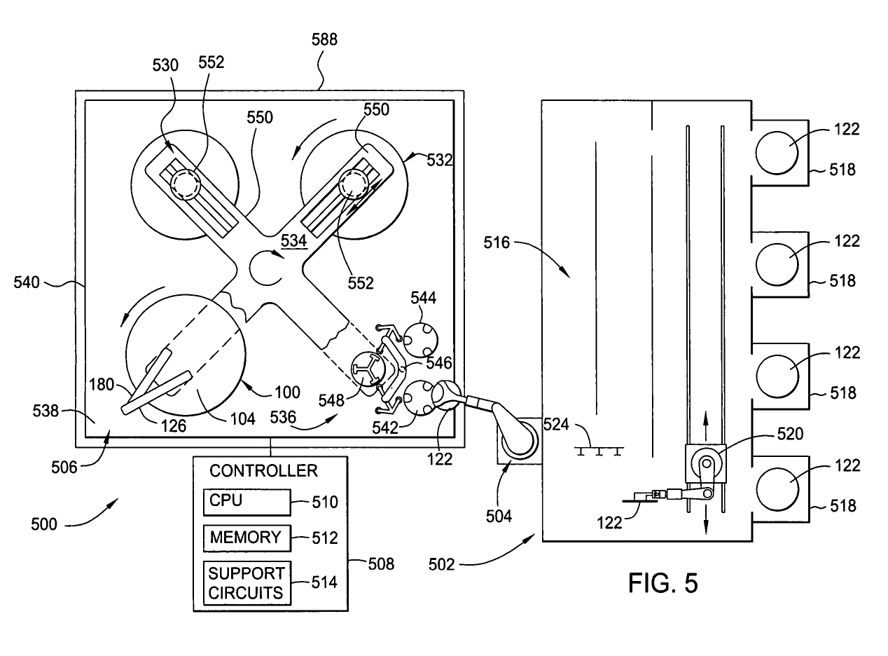

FIG. 5 is a plan view of one embodiment of a planarization system 500 having an apparatus for electrochemically processing a substrate. The exemplary system 500 generally comprises a factory interface 502, a loading robot 504, and a planarizing module 506. The loading robot 504 is disposed proximate the factory interface 502 and the planarizing module 506 to facilitate the transfer of substrates 122 therebetween.

A controller 508 is provided to facilitate control and integration of the modules of the system 500. The controller 508 comprises a central processing unit (CPU) 510, a memory 512, and support circuits 514. The controller 508 is coupled to the various components of the system 500 to facilitate control of, for example, the distribution of electrolyte, and the position of the fluid delivery arm assembly 126, the position of the foam removal assembly 180, the speed of the platen 104, and positioning of the carrier head 102. The control system can optimize the distribution of electrolyte to the surface of the polishing pad 108 and prevent collisions between the foam removal assembly 180 and the carrier head 102.

The factory interface 502 generally includes a cleaning module 516 and one or more wafer cassettes 518. An interface robot 520 is employed to transfer substrates 122 between the wafer cassettes 518, the cleaning module 516 and an input module 524. The input module 524 is positioned to facilitate transfer of substrates 122 between the planarizing module 506 and the factory interface 502 by grippers, for example vacuum grippers or mechanical clamps.

The planarizing module 506 includes at least the first electrochemical mechanical planarizing (ECMP) station 100, with the foam removal assembly 180 and fluid delivery arm assembly 126 and optionally, at least one conventional chemical mechanical planarizing (CMP) stations 532 disposed in an environmentally controlled enclosure 588. Examples of planarizing modules 506 that can be adapted to benefit from the invention include MIRRA®, MIRRA MESA®, REFLEXION®, REFLEXION® LK, and REFLEXION LK Ecmp™ Chemical Mechanical Planarizing Systems, all available from Applied Materials, Inc. of Santa Clara, Calif. Other planarizing modules, including those that use processing pads, planarizing webs, or a combination thereof, and those that move a substrate relative to a planarizing surface in a rotational, linear or other planar motion may also be adapted to benefit from the invention.

In the embodiment depicted in FIG. 1, the planarizing module 506 includes the first ECMP station 100, a second ECMP station 530 and one CMP station 532. Bulk removal of conductive material from the substrate is performed through an electrochemical dissolution process at the first ECMP station 100. After the bulk material removal at the first ECMP station 100, residual conductive material is removed from the substrate at the second ECMP station 530 through a second electrochemical mechanical process. It is contemplated that more than one residual ECMP stations 530 may be utilized in the planarizing module 506.

A conventional chemical mechanical planarizing process is performed at the planarizing station 532 after processing at the second ECMP station 530. An example of a conventional CMP process for the removal of copper is described in U.S. Pat. No. 6,451,697, issued Sep. 17, 2002, which is incorporated by reference in its entirety. An example of a conventional CMP process for the barrier removal is described in U.S. patent application Ser. No. 10/187,857, filed Jun. 27, 2002, which is incorporated by reference in its entirety. It is contemplated that other CMP processes may be alternatively performed. As the CMP stations 532 are conventional in nature, further description thereof has been omitted for the sake of brevity.

The exemplary planarizing module 506 also includes a transfer station 536 and a carousel 534 that are disposed on an upper or first side 538 of a machine base 540. In one embodiment, the transfer station 536 includes an input buffer station 542, an output buffer station 544, a transfer robot 546, and a load cup assembly 548. The input buffer station 542 receives substrates from the factory interface 502 by the loading robot 504. The loading robot 504 is also utilized to return polished substrates from the output buffer station 544 to the factory interface 502. The transfer robot 546 is utilized to move substrates between the buffer stations 542, 544 and the load cup assembly 548.

In one embodiment, the transfer robot 546 includes two gripper assemblies, each having pneumatic gripper fingers that hold the substrate by the substrate's edge. The transfer robot 546 may simultaneously transfer a substrate to be processed from the input buffer station 542 to the load cup assembly 548 while transferring a processed substrate from the load cup assembly 548 to the output buffer station 544. An example of a transfer station that may be used to advantage is described in U.S. Pat. No. 6,156,124, issued Dec. 5, 2000 to Tobin, which is herein incorporated by reference in its entirety.

The carousel 534 is centrally disposed on the base 540. The carousel 534 typically includes a plurality of arms 550, each supporting a planarizing head assembly 552. Two of the arms 550 depicted in FIG. 5 are shown in phantom such that a planarizing surface of the first ECMP station 100 and the transfer station 536 may be seen. The carousel 534 is indexable such that the planarizing head assemblies 552 may be moved between the planarizing stations 100, 532 and the transfer station 536. One carousel that may be utilized to advantage is described in U.S. Pat. No. 5,804,507, issued Sep. 8, 1998 to Perlov, et al., which is hereby incorporated by reference in its entirety.

A conditioning device (not shown) is disposed on the base 540 adjacent each of the planarizing stations 100, 530, and 532. The conditioning device periodically conditions the planarizing material disposed in the stations 100, 530, and 532 to maintain uniform planarizing results.

One exemplary embodiment of an electrically conductive processing solution includes an acid based electrolyte, a first chelating agent having a carboxylate function group, a passivating polymeric material, a second chelating agent having an amine function group, an amide function group, or combinations thereof, a pH adjusting agent to provide a pH between about 3 and about 8, and a solvent. Embodiments of the electrically conductive processing solution may be used for polishing bulk and/or residual materials. The processing solution may optionally include one or more corrosion inhibitors or a polishing enhancing material, such as abrasive particles. While the compositions described herein are oxidizer free compositions, the invention contemplates the use of oxidizers as a polishing enhancing material that may further be used with an abrasive material. It is believed that the polishing compositions described herein improve the effective removal rate of materials, such as tungsten, from the substrate surface during ECMP, with a reduction in planarization type defects and yielding a smoother substrate surface. This processing solution described herein is just one exemplary embodiment. This invention contemplates the use of other processing solutions.

While the foregoing is directed to embodiments of the present invention, other and further embodiments of the invention may be devised without departing from the basic scope thereof, and the scope thereof is determined by the claims that follow.

1. A processing system for planarizing a substrate, comprising:
a platen;
a pad disposed on the platen;
a carrier head configured to retain the substrate against the pad while contacting an electronically conductive processing solution; and
a foam removal assembly configured to remove foam from the electrically conductive processing solution, wherein a gap exists between a surface of the electrically conductive processing solution and a bottom edge of the foam removal assembly.

2. The processing system of claim 1 further comprising:
an electrode disposed between the platen and the pad; and
a power source having a pole coupled to the electrode.

3. The processing system of claim 3, wherein the foam removal assembly is attached to a fluid delivery arm.

4. The processing system of claim 1, wherein the foam removal assembly is vertically adjustable above the pad.

5. The processing system of claim 1, wherein the foam removal assembly is positioned at an angle in a plane parallel to the platen between about 20° and about 70° relative to an edge of the platen.

6. The processing system of claim 5, wherein the angle is between about 30° to about 45°.

7. The processing system of claim 1, wherein the foam removal assembly is inclined at a downward angle in a direction of rotation.

8. The processing system of claim 3, wherein the foam removal assembly is attached to a distal end of the fluid delivery arm.

9. The processing system of claim 8, wherein the foam removal assembly is positioned at an angle in a plane parallel to the platen between about 60° and about 100° relative to the fluid delivery arm.

10. The processing system of claim 9, wherein the foam removal assembly is positioned at an angle in a plane parallel to the platen of about 90° relative to the fluid delivery arm.

11. An apparatus for defoaming an electrochemical mechanical polishing bath, comprising a foam removal assembly attached to a fluid delivery arm.

12. The apparatus of claim 11, wherein the foam removal assembly is rotationally adjustable relative to the fluid delivery arm.

13. The apparatus of claim 11, wherein the foam removal assembly is vertically adjustable.

14. The apparatus of claim 11, wherein a gap exists between a surface of the electrochemical mechanical polishing bath and a bottom edge of the foam removal assembly.

15. The apparatus of claim 13, wherein the blade comprises a material selected from the group consisting of PPS, PEEK, stainless steel, copper, gold, silver, tungsten, palladium, bronze, brass, or some combination thereof.

16. A method of electrochemically and mechanically planarizing a surface of a substrate, comprising:
providing a basin containing an electrically conductive solution and an electrode disposed therein;
disposing a polishing medium in the electrically conductive solution;
positioning a substrate against the polishing medium so that a surface of the substrate contacts the electrically conductive solution;
providing relative motion between the substrate and the polishing medium;
applying a potential between the polishing medium and the electrode; and
skimming a surface of the electrically conductive solution with a foam removal assembly.

17. The method of claim 16, wherein the height of the foam removal assembly is vertically adjustable above the polishing medium.

18. The method of claim 17, wherein the foam removal assembly is configured at an angle so that the foam collected by the foam removal assembly is removed by the natural flow of the electrically conductive solution.

19. The method of claim 16, wherein a gap exists between the polishing medium and a bottom edge of the foam removal assembly.

20. The method of claim 19 wherein the gap is greater than the height of the electrically conductive solution.
